(19) United States
(12) Patent Application Publication
(10) Pub. No.: US 2016/0331101 A1
(43) Pub. Date: Nov. 17, 2016

(54) Cosmetic Camera

(71) Applicant: James R. Lewis, Webster, TX (US)

(72) Inventor: James R. Lewis, Webster, TX (US)

(21) Appl. No.: 14/710,722

(22) Filed: May 13, 2015

(51) Int. Cl. A45D 33/26; H04N 5/225; A45D 33/00

(52) U.S. Cl. CPC A45D 33/26; A45D 33/008; H04N 5/2257

(57) ABSTRACT

According to the present invention a compact is provided with a bottom part having space for keeping the makeup powder also. There is a SD slot for saving images in the SD card or the like. In accordance with the invention, a compact is provided with solar re-chargeable batteries as a source of power supply. In view of the foregoing, a makeup mirror apparatus is suggested, in which it is possible to easily finish one's makeup in a beautiful state. The compact of the invention is used for taking self-pictures by the user. Preferably the compact addresses the problem of taking pictures by someone else or using other options of camera like phone cameras of the user after she is finished with a makeover. The compact is portable and can be easily carried by the user anywhere in her purse. The compact that has a two way mirror at one end/face and a camera installed on top of the two way mirror and a camera button on the back side of the compact. The compact is provided with batteries in the battery housing at the back end.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to cosmetic compacts that are used for beauty enhancement by women. More particularly, the invention relates to cosmetic compacts that are adapted to have dual use, with the more specific use being clicking a self-picture by the user after applying makeup.

(2) Background of the Invention

Women have been wearing cosmetics to enhance their physical appearance for centuries. Cosmetics containers are well known in the art. A large variety of such containers are currently commercialized and sold. They include small cases, such as tubes or circular cases for containing lipstick, mascara, eyeliner, lip liner, nail polish, and other health and beauty aids. Such containers, with the cosmetics included therein, are widely used by people from adolescence to old age.

Women have typically carried their cosmetics with them in abbreviated form by using containers known as “compacts” that they keep in a handbag, in which they also keep other personal items, such as a wallet, keys, tissues, pens, notepads, etc. for convenience. In order to conserve space in a woman's handbag, compacts are typically made to be relatively thin with a mirror integrated within the compact. The compact will typically have one or more small compartments for each composition of makeup contained therein. In this manner, a woman can touch up her makeup throughout the day without the need for an entire collection of separate bottles and containers.

In recent years, the wearing of cosmetics has also become more popular with teenage girls. However, today's teenage girls generally shun the use of handbags, and are most often seen wearing casual clothes and carrying only those items they considered as essential to their daily life. Typically, these essentials are limited to a form of identification, money, and a cell phone or other type of personal electronics device, such as a personal digital assistant or a digital electronic game. Since they shun the carrying of handbags, these adolescent girls are limited in the number and bulk of items that they can carry on their person. Additionally, adolescent girls are always looking for new and unique items to enhance their appearance and stature among their peers.

Cosmetic compacts are well known. Typically, a cosmetic compact houses one or more cosmetic products and auxiliary aids, such as a mirror or an applicator.

Cosmetic compacts that house a power source are known. For example, various prior arts disclose a makeup compact case that has light emitting diodes, which are powered by a low-voltage lithium battery operated by a switch. There is also a combined cosmetic compact and cell phone, for the user's convenience. These flip-open type cell phones have recessed surfaces for holding cosmetic receptacles and an applicator. The cell phone display in such cases is able to operate as a mirror or as a digital display.

For a long time, women have been carrying cosmetics and cosmetic devices, in a handbag, for example. Recently, there has been interest in portable cosmetic devices that consume power and convert it into another form, such as vibration, heat, or light, etc. For example, vibrating mascara applicators are known, as are heated cosmetic applicators.

The increase in the availability and use of portable devices that require a power source presents a problem. For one, the number of items in a woman's handbag keeps going up. Second, each electronic portable device has associated hardware for recharging the device. A woman may not want to carry that hardware around as well. Even if she does, there is not necessarily a convenient place to plug it in; and if there is, the device is no longer portable while it is plugged in. The solution to the problem is to replace an item that many women already carry around with them with a portable device, according to the present invention, that is able to power, recharge, interface with, and effect data transfer between a myriad of personal digital devices and electronic cosmetic appliances, all while being carried on one's person.

There is a constant pleasure that drives women to spend more time, money, and effort on looking good, and, thus, it's generally the makeup expenditure that is exorbitant in today's women expenditures. They like to dress up with the best makeup, and like to take pictures for showing them to their friends. The invention discussed here solves this problem faced by women/girls by providing a compact with a built in camera placed in a two way mirror of a makeup compact case, which can be used to click a self-picture by the user immediately after applying the makeup for the best look.

It is an aspect of the invention to overcome or alleviate a problem of the prior art.

This permits the use of the present invention, which enhances the prior art of taking pictures singularly, while using a compact case.

### SUMMARY OF THE INVENTION

In view of the foregoing, it is another objective of the present invention to provide a makeup mirror apparatus in which it is possible to easily finish one's makeup in a beautiful state.

One objective of the various disclosed embodiments of the present invention is to provide a compact for taking self-pictures by the user.

Preferably, the compact addresses the problem of having someone else take picture or needing to use other cameras, such as phone cameras, after she is finished with her make-over.

Accordingly, it is a primary objective of the present invention to provide a compact that is portable and can be easily carried by the user anywhere in her purse.

It is yet another objective of the present invention to provide a compact that has a two-way mirror at one end/face.

It is yet another objective of the present invention to provide a compact with a two-way mirror and a camera installed on the top of the two way mirror. The camera may be placed behind the two way mirror for protection.

It is still another objective of the present invention to provide a compact with a two-way mirror and a camera installed on top of the two-way mirror with a camera button on the backside of the compact.

It is still another objective of the present invention to provide a compact with batteries that are in the battery housing at the back end.

It is still another objective of the present invention to provide a compact with batteries in the battery housing together with a SD slot at the back end.

Other objectives of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates perspective front view of the open compact, according to the preferred embodiment of the present invention.

FIG. 2 illustrates an open perspective back view of the compact, according to the preferred embodiment of the present invention.

### DETAILED DESCRIPTION OF THE INVENTION

The following detailed description of the present invention enables teaching of the invention and its best, currently know embodiment. Those skilled in the art can understand that many changes can be made in the embodiments described, while still obtaining beneficial results of the present invention. It will also be apparent that some of the desired benefits of the present invention can be obtained by selecting some of the features of the invention, while not utilizing other features. Accordingly, those working in the relevant art will recognize that many adaptations and modification to the present invention can be made, may be desired in certain circumstances, and are part of the present invention. Thus, the following description is provided as illustrative of the principle of the present invention, and not in limitation thereof.

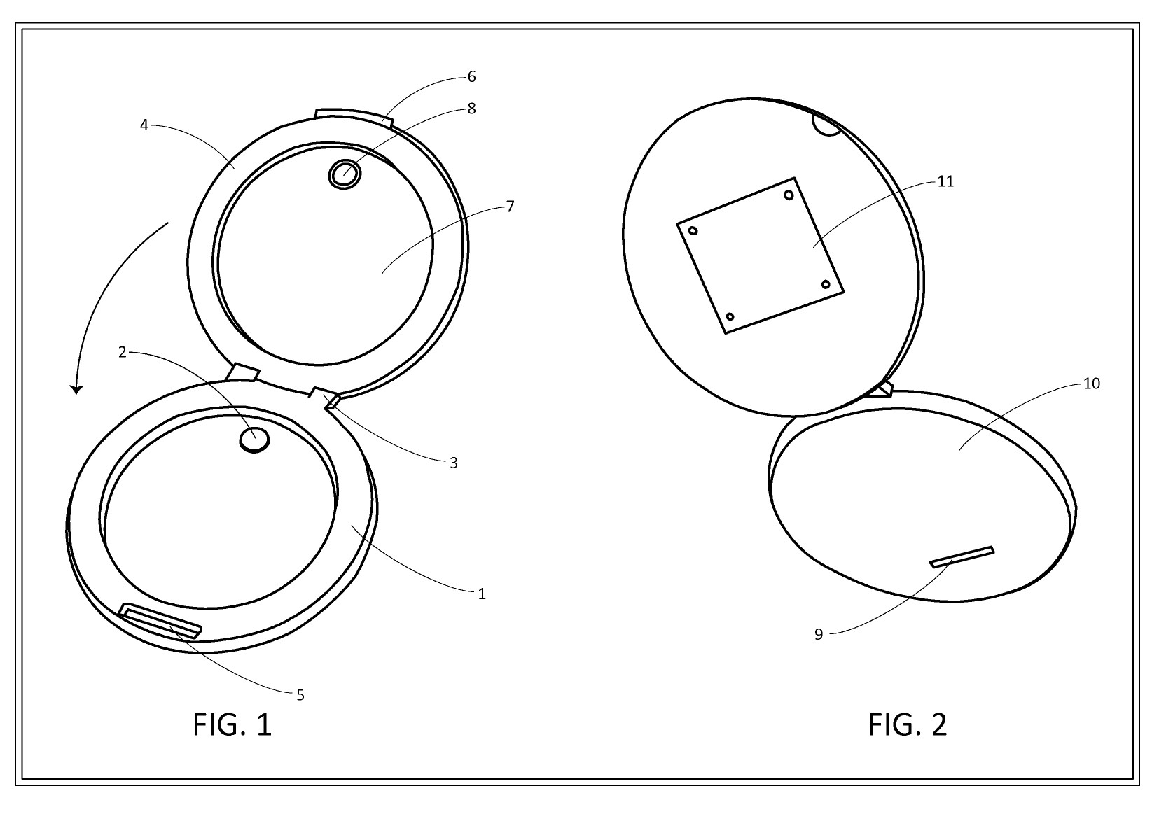

Embodiments of the present invention provide a compact that is divided into two parts—top and bottom parts respectively. The top part of the compact, described in the invention, is joined to the bottom part with hinges, as shown in FIGS. 1 and 2.

Embodiments of the product are shown in the figures and discussed below. It should be understood that the operations, as presented, are exemplary, and that some operations may be substituted, added, rearranged, or removed while still encompassing inventive subject matter. Moreover, it should be understood that the order of operations is not to be limited, unless explicitly specified herein.

As will be appreciated by one skilled in the art, aspects of the present inventive subject matter may be embodied as a dual purpose beauty product. Accordingly, aspects of the present inventive subject matter may take the form of a beauty product used as a compact, to take a picture of the user by oneself, using the camera feature installed in the invention, and the other aspects that may all generally be referred to herein.

Aspects of the present inventive subject matter are described with reference to the figures provided herein.

FIG. 1 illustrates a perspective view of the bottom half of the compact 1, according to the preferred embodiment of the present invention. The figure shows the bottom half of the mirror that is provided with a flash feature 2 for a better quality of images. Also shown is a hinge 3 that is used to join the top 4 and bottom part of the compact. The bottom latch 5 is also provided to ensure a secure closing of the compact.

The top latch 6 and bottom latch, which combine with each other, thereby giving a strong fastening/closing and securing the contents within the compact. Also visible is the two-way mirror 7, which is provided on the top part of the invention. A camera 8 is placed near the two-way mirror, which facilitates the user to immediately click her picture without any need of any phone camera or other digital camera for the same purpose. The user is able to easily click her picture using the same compact after she is thorough applying her makeup.

FIG. 2 illustrates the rear view of the compact, according to the preferred embodiment of the present invention. This figure shows a SD Slot 9 at the rear 10 end of the compact. This SD slot can house an SD card to save all the pictures that the user takes. The batteries (4 or more s desired) are placed in the battery housing 11.

FIG. 5 illustrates the front view of the top half of the compact, according to the preferred embodiment of the present invention.

The camera button 12 at the top rear end of the compact activates the camera use.

In the preferred embodiment of the present invention, it is a compact that is lightweight, portable, or easy to carry.

According to a preferred embodiment of the present invention, a compact is provided with a bottom part, where there is also space for keeping the makeup powder.

According to a preferred embodiment of the present invention, is an SD slot for saving Images to an SD card or the like.

In accordance with the invention, a compact is provided with solar re-chargeable batteries as a source of power supply. The compact may also use an external battery charger.

In view of the foregoing, it is another objective of the present invention to provide a makeup mirror apparatus, in which it is possible to easily finish one's makeup in a beautiful state.

One objective of the various disclosed embodiments of the present invention is to provide a compact for taking self-pictures.

Preferably, the compact addresses the problem of having someone else take picture or needing to use other cameras, such as phone cameras, after she is finished with her make-over.

Accordingly, it is a primary objective of the present invention to provide a compact that is portable and can be easily carried by the user anywhere in her purse.

It is yet another objective of the present invention to provide a compact that has a two-way mirror at one end/face.

It is yet another objective of the present invention to provide a compact with a two-way mirror and a camera installed on top of the two way mirror.

It is still another objective of the present invention to provide a compact with a two way mirror and a camera installed on top of the two way mirror with a camera button on the back side of the compact.

It is still another objective of the present invention to provide a compact with batteries in the battery housing at the back end.

It is yet another objective of the present invention to provide a compact with batteries in the battery housing together with an SD slot at the back end.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned, and may fall within the scope of the inventive subject matter. In general, structures and functionality that are presented as separate components in the exemplary configurations may be implemented as a combined structure or component. Similarly, structures and functionality that are presented as a single component may be implemented as separate components. These and other variations, modifications, additions, and improvements may fall

I claim:

1. A makeup mirror compact comprises of:
a bottom half having a SD slot and a bottom latch;
a top half having a battery housing and a top latch;
a connected hinge;
a camera;
a camera button;
a SD slot;
a SD card;
a two way mirror; and
batteries.

2. The makeup mirror compact of claim 1, wherein said top half and said bottom half are coupled by said connected hinge.

3. The makeup mirror compact of claim 1, wherein said top latch and said bottom latch ensure a secure closing of said compact.

4. The makeup mirror compact of claim 1, wherein said compact is used for taking pictures and self-pictures by the user.

5. The makeup mirror compact of claim 1, wherein said two way mirror is a two way mirror at one end/face.

6. The makeup mirror compact of claim 1, wherein said camera is installed on top of said two way mirror.

7. The makeup mirror compact of claim 1, wherein said bottom half having a flash feature.

8. The makeup mirror compact of claim 1, wherein said camera button located on the back side of said compact.

9. The makeup mirror compact of claim 1, wherein said batteries are placed into said battery housing at the back end of top half of said compact.

10. A makeup mirror compact of claim 1, wherein said batteries are rechargeable batteries.

11. The makeup mirror compact of claim 1, wherein said SD slot located at the back end of said top half compact.

12. The makeup mirror compact of claim 1, wherein said compact is portable and can be easily carried by the user anywhere in purse of the user.

13. The makeup mirror compact of claim 1, wherein said compact can use as an external battery charger.
